(19) United States
(12) Patent Application Publication
(10) Pub. No.: US 2008/0250760 A1
(43) Pub. Date: Oct. 16, 2008

(54) Horse Bit

(76) Inventor: Heather Jane Margaret Hyde-Saddington, Cleveland (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/815,780

(22) PCT Filed: Feb. 8, 2006
(86) PCT No.: PCT/GB06/00446

§ 371 Date: Jan. 4, 2008

(30) Foreign Application Priority Data
Feb. 9, 2005 (GB) 0502610.9

(51) Int. Cl. B68B 1/06

(52) U.S. Cl. 54/8

(57) ABSTRACT

A snaffle bit (10) comprises two side rings (12) and a shackle (14) between them. The shackle has two side portions (16) and a central lozenge portion (18). The articulation axis (30) of the lozenge and the plane (22) of articulation the side rings (12), are inclined with respect to each other by between 18° and 30°. The side portions (16) may be curved forwardly.

This invention relates to horse bits.

### BACKGROUND

U.S. Pat. No. 895,419 (Bristol) discloses a driving bit comprising two side rings and a shackle between them, the shackle having two side portions and a central plate portion, the plate portion being pivoted to the side portions about an articulation axis and the side rings passing through bores in the ends of the side portions and defining a plane, wherein the articulation axis is arranged so that the plate lies flat on the horse's tongue. The bit is said to be comfortable and responsive.

U.S. Pat. No. 6,425,229 (Sprenger) discloses a snaffle bit comprising two side rings and a shackle between them, the shackle having two side portions and a central lozenge portion, the lozenge portion being pivoted to the side portions about an articulation axis and the side rings passing through bores in the ends of the side portions and defining a plane, wherein the articulation axis is at 45°±20°.

The effect of this arrangement is that the lozenge does not lie flat on a horse's tongue when the bit is worn by the horse. When the reins are pulled, a particularly strong pressure is applied to the horse's tongue which is very effective in capturing the horse's attention and demanding immediate response.

The lozenge central portion, as opposed to a plate, softens the contact with the horse's tongue. A lozenge is oval shaped, somewhat like a rugby ball, but with squeezed ends through which eyes are formed to link with the side portions of the shackle. The lozenge disguises, to a certain extent, the changes in contour of the shackle caused by the links, as well as having rounded edges.

Nevertheless, the responsiveness of the Sprenger bit is strong and the bit is very useful for training horses. On the other hand, it is often found that a horse ceases to remain responsive to after a period of time, usually after about two hours of riding. In fact, it is thought that the constant pressing on the tongue by the edge of the lozenge sensitises the horse so much that it constantly attempts to remove the object from its mouth. Eventually, the bit has the opposite effect by desensitizing the horse, leaving the bit dead in its mouth.

It is an object of the present invention to provide an improved bit.

### BRIEF SUMMARY OF THE DISCLOSURE

In accordance with the present invention there is a provided a horse bit comprising two side elements and a shackle between them, the shackle having two side portions and a central lozenge portion, the lozenge portion being pivoted to the side portions about an articulation axis and the side elements passing through bores in the ends of the side portions, said bores, when the elements are separated and tensioned, lying in and defining a ring plane, wherein the articulation axis is at between 18° and 30° to said ring plane.

What is meant by “when the elements are separated” is simply that the components of a horse bit tend to be quite loosely arranged together and this manoeuvre merely serves to compose the disposition of the components whereby the requisite angles can be defined. Thus, the side elements are gripped and pulled apart until the entire bit is taut and lies, essentially, in a single plane. The side elements are then twisted to ensure that there bores lie in the same, single, plane, thus defining the “ring plane” and the intermediate components are substantially in line. The articulation axis of the lozenge then can be identified with respect to the ring plane.

Preferably, said angle of articulation is between 18° and 25° to said ring plane, or between 18° and 24° to said ring plane, or is 20°.

The side elements may be rings slidable in said bores. In which event said bit is a snaffle bit.

It is found that with an articulation axis at less than 20°, the lozenge lies flat on the horse's tongue, like the Bristol bit, and therefore lacks responsiveness, is but at above 20° does have the desired responsiveness. Also, it is found that, with an articulation axis at less than 30°, the tongue does not become desensitised with time. It is found that the horse can wear the bit continuously for as long as with softer bits (i.e. for up to 8 hours at a time) but nevertheless the effectiveness of the bit in capturing the horse's attention when the reins are pulled remains. Consequently, the bit according to the invention need not be limited to training, but can be used full-time.

Said side portions may be curved, whereby the shackle as a whole adopts a curved orientation in the horse's mouth to accommodate different shapes of mouth. Preferably, said curvature is in a curve plane substantially orthogonal to said ring plane.

For the avoidance of doubt, it should be pointed out that the side rings, in use, while the bit is worn by a horse, do not lie in the ring plane but in different planes substantially orthogonal thereto and parallel to one another. Only those parts of the side rings passing through each bore of the side portions is always in the ring plane.

In another aspect, the present invention also provides a snaffle bit comprising two side rings and a shackle between them, the shackle having two side portions being pivoted with respect to one another, the side rings passing through bores in the ends of the side portions and defining a ring plane, wherein said side portions are bent in a curve plane substantially orthogonal said ring plane.

A central lozenge portion may be disposed between, and articulated to, the side portions.

Consequently, instead of bending upwards in a horse's mouth, as the is curvature in EP-A-0017959 provides, the present invention provides that the shackle curves forwardly in the horse's mouth.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

Features, integers, characteristics, compounds, chemical moieties or groups described in conjunction with a particular aspect, embodiment or example of the invention are to be understood to be applicable to any other aspect, embodiment or example described herein unless incompatible therewith.

The invention is further described hereinafter, by way of example, with reference to the accompanying drawings, in which:

FIG. 1 a front view of a snaffle bit in accordance with the present invention;

FIG. 2 is a section on the line II-II in FIG. 1;

FIGS. 3a and b are side views of alternative side portions for a bit in accordance with the present invention;

FIG. 4 is a view similar to FIG. 2, but of a bit with curved side portions of the type illustrated in FIG. 3a or b; and,

FIGS. 5a, b and c, show views of other forms of bit having different cheek pieces.

### DETAILED DESCRIPTION

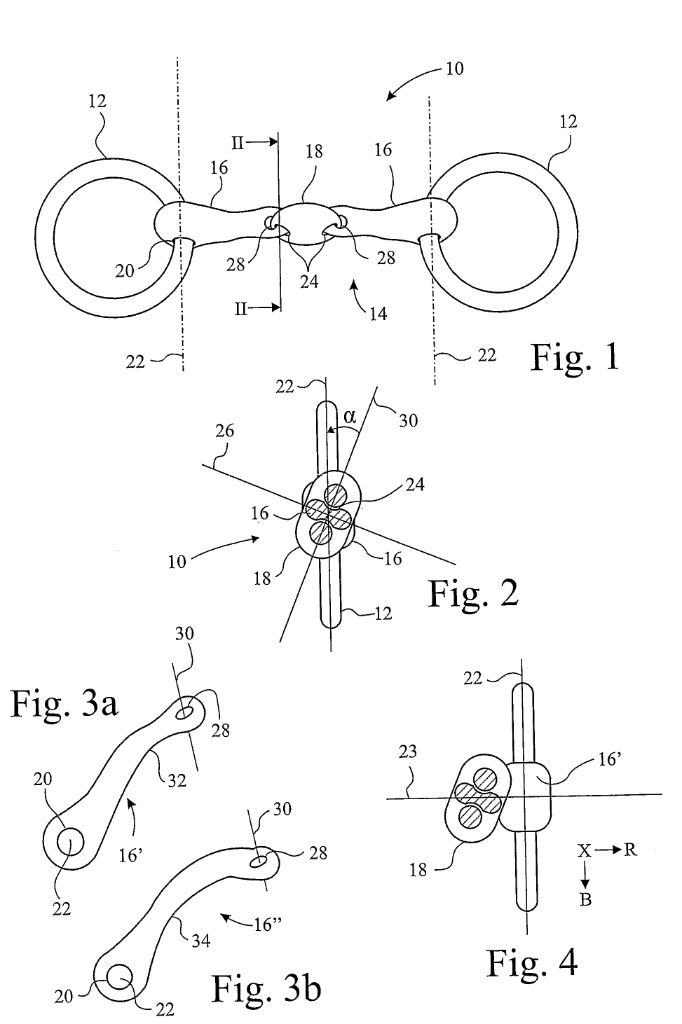

In FIGS. 1 and 2, a snaffle bit 10, which is an embodiment of the present invention, comprises two side rings 12 joined by a shackle 14. The shackle 14 comprises two side portions 16 and a central lozenge portion 18.

At one end of each side portion 16, there is an aperture 20 through which the rings 12 are a sliding fit. The apertures 20 define axes 22 which, together, define a ring plane that contains both axes.

Central lozenge portion 18 is an oval shaped body, somewhat like a flattened rugby ball whose ends are squeezed and provided with apertures 24 having axes 26.

At their other end, side portions 16 are provided with apertures 28 that link with the apertures 24 in the lozenge portion 18. The axes 30 of apertures 28 in the side portions 16 define an articulation axis 30 for the side portion with respect to the lozenge 18.

The side portions 16 are so arranged that the axis 22 is inclined with the respect to the axis 30 by an angle α. The angle α is arranged to be 20°. This angle results in the lozenge 18 being inclined with respect to the horse's tongue (not shown) when the bit is correctly fitted in a horse's mouth. A pull on the reins (not shown, but connected to the rings 12) will result in the bottom edge of the lozenge 18 pressing acutely onto the horse's tongue. This causes the horse to take note of the command. However, the inclination is not so much that the edge of the lozenge is permanently pressing on the horse's tongue, even when the contact normally applied when a rider takes command of their horse is effected. That is to say, the gentle tension applied by the rider to both reins. However, even with only small increases in the tension applied, to one or other rein, the angulation of the lozenge 18 causes an increase in pressure on the horse's tongue, bringing it to attention.

On the other hand, as mentioned above, because the angulation is limited and the lozenge is “soft” (minimizing the changes in contour across the horse's mouth by reason of the eyes 24,28) the bit 10 can be worn by the horse for extended periods of time without the horse's tongue becoming desensitised.

Referring to FIGS. 3a and b, two different, alternative side portions 16′ and 16″ are illustrated. Side portion 16′ has a kink 30, which is in a curve plane 23 orthogonal the ring plane 22. [Curve plane 23 is the plane of the paper in FIGS. 3a,b, whereas both the curve plane 23 and ring plane 22 are orthogonal to the plane of the paper in FIG. 4.] Portion 16″ has a gentle curvature over its entire length 34 between apertures 20,28, but in the same curve plane as that containing the kink 32.

Apertures 28 are arranged on portions 16′,16″ so that lozenge 18 sits on the tongue of the horse for which these side portions are designed in the same orientation as does the lozenge 18 of the FIGS. 1 and 2 arrangement.

This curvature of the arms 16′,16″, regardless of the angle of connection lozenge 18, results in a general forward curvature with respect to a horse's mouth. This better suits some horses which are so anatomically shaped that the tongue should be behind and below the bit, rather than entirely underneath it.

With the lozenge arranged in the same way as described above with respect to FIGS. 1 and 2, however, both the anatomical shape of the horse's mouth, and the desired responsiveness with absent-desensitising can be provided. In this respect, FIG. 4 is an equivalent view to that of FIG. 2. Here, however, the directions of the rear and bottom of the horse's mouth, when the bit is fitted correctly therein, are shown by the arrows XR and XB respectively.

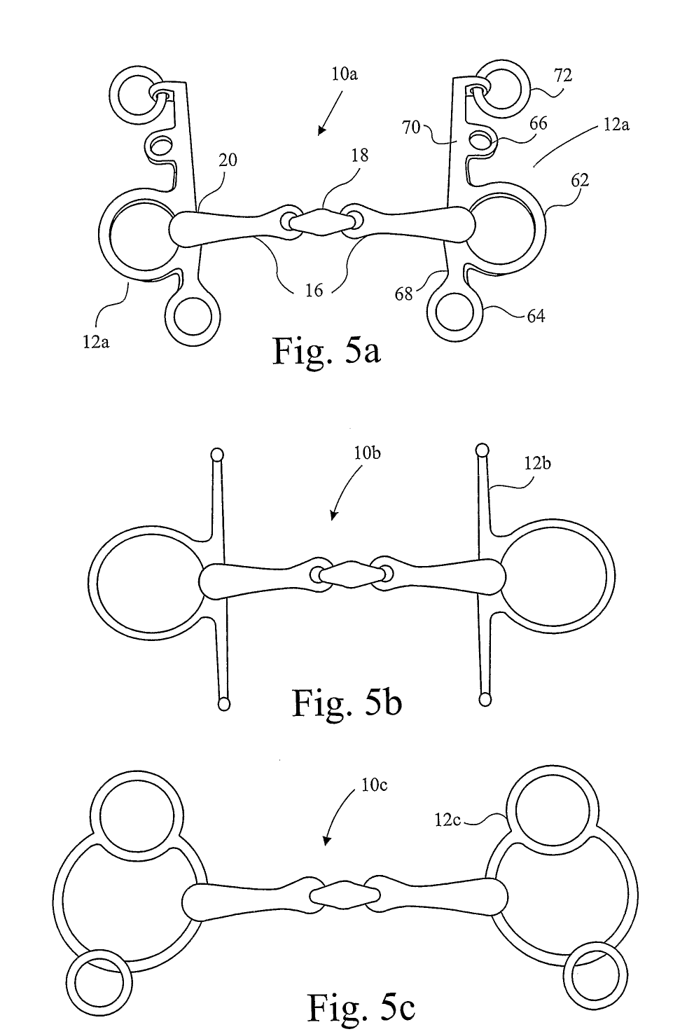

The snaffle bit 10 illustrates merely one form of cheek piece with which the present invention finds application. In FIGS. 5a, b and c, a Pelham bit 10a, a Nelson Gag bit 10b, and a Universal bit 10c, are shown. The same side portions 16 and lozenge 18 are employed, with the same angulation as described above. However, the cheek pieces 12a are not here simple rings 12 as described above, but the more complex arrangement the particular bit in question. Thus the Pelham bit 10a of FIG. 5a has a fixed main ring 62 that passes through bores or apertures 20 on the ends of the side portions 16, and two subsidiary rings 64,66, on the end and side respectively of extensions 68,70 from the ring 62. Another loose ring 72 is also provided. Such arrangements are known and do not require description herein. For example, the cheek pieces 12b and c of the Nelson Gag bit 10b and the Universal bit 10c of FIGS. 5b and c will be familiar to those skilled in the art. Other forms of bit, also known to those skilled in the art, can be employed with the present invention. For example, it is possible to have Fullcheek or Halfcheek, bits, Eggbutt Bradoon or Cheltenham Gag bits, or Beval or Baucher bits, as well as the bits described and illustrated herein.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A horse bit comprising two side elements and a shackle between them, the shackle having two side portions and a central lozenge portion, the lozenge portion being pivoted to the side portions about an articulation axis and the side elements passing through bores in the ends of the side portions, said bores, when the elements are separated and tensioned, lying in and defining a ring plane, wherein the articulation axis is at between 18° and 30° to said ring plane.

2. A bit as claimed in claim 1, in which the articulation axis is at between 18° and 25° to said ring plane.

3. A bit as claimed in claim 1, in which the articulation axis is at between 18° and 24° to said ring plane.

4. A bit as claimed in claim 1, in which the articulation axis is at 20° to said ring plane.

5. A bit as claimed in claim 1, in which said side elements are rings slidable in said bores, said bit thereby being a snaffle bit.

6. A bit as claimed in claim 1, in which said side portions are curved, whereby the shackle as a whole adopts a curved orientation in the horse's mouth to accommodate different shapes of mouth.

7. A bit as claimed in claim 6, in which said curvature is in a curve plane substantially orthogonal to said ring plane.

8. A snaffle bit comprising two side rings and a shackle between them, the shackle having two side portions being pivoted with respect to one another, the side rings passing through bores in the ends of the side portions and defining a ring plane, wherein said side portions are bent in a curve plane substantially orthogonal said ring plane.

9. A snaffle bit as claimed in claim 8, in which a central lozenge portion is disposed between, and articulated to, the side portions.

10. (canceled)
